(19) United States
(12) Patent Application Publication
(10) Pub. No.: US 2014/0265692 A1
(43) Pub. Date: Sep. 18, 2014

(54) PARTIAL FLOW GUIDE, IN PARTICULAR OF A MAGNETIC COUPLING PUMP

(71) Applicant: Ruhrpumpen GmbH, Witten (DE)

(72) Inventors: Günther Schneider, Herne (DE); Michael Westib, Bochum (DE)

(21) Appl. No.: 14/353,471

(22) PCT Filed: Sep. 24, 2012
(86) PCT No.: PCT/DE2012/000941

§ 371 Date: Apr. 22, 2014

(30) Foreign Application Priority Data
Oct. 28, 2011 (DE) 10 2011 117 183.9

(51) Int. Cl. H02K 49/10

(52) U.S. Cl. CPC H02K 49/106
USPC 310/104

(57) ABSTRACT

The invention relates to a conveying element (1), which comprises a shaft (2) with a through-bore (26) and sliding bearings (4, 4a, 4b), wherein a first drive element (17) is disposed on the shaft (2). The conveying element in the preferred embodiment as a magnetic coupling pump (1) or as a canned motor pump is characterized in that there is disposed in the first drive element (17) or in the first internal magnetic rotor (17) at least one channel system (41), which adjoins a connecting bore (42) emerging in the through-bore (26) of the shaft (2).

The invention relates to a conveying element, for example a magnetic coupling pump or for example a canned motor pump, wherein the conveying element comprises a shaft with a through-bore and an impeller-side sliding bearing and a sliding bearing remote from the impeller, and wherein a first drive element is disposed on the shaft.

Such conveying elements in the exemplary embodiment as magnetic coupling pumps are generally known, and described for example in DE 10 2009 022 916 A1. The pump output is transmitted from a driveshaft via a magnet-carrying rotor (external rotor) contactless and essentially slip-free to the pump-side magnet carrier (internal rotor, first drive element). The internal rotor or the first drive element drives the pump shaft, which is mounted in a sliding bearing lubricated by the conveying medium, i.e. in a hydrodynamic sliding bearing. A containment shroud with its cylindrical wall lies between the external rotor and the internal rotor, i.e. between the external and internal magnets. The containment shroud is connected with its flange to a pump component, for example a housing cover, and opposite thereto comprises a closed base. The containment shroud, i.e. the magnetic coupling pump, reliably separates the product space from the surroundings, so that the risk of a product escaping with all the associated unfavorable consequences can be excluded. A magnetic coupling pump is accordingly the combination of conventional pump hydraulics with a magnetic drive system. This system uses the forces of attraction and repulsion between magnets in the two coupling halves for the contactless and slip-free torque transmission. The magnetic coupling pump therefore offers great advantages especially when dealing with very valuable or very dangerous substances.

EP 0 814 275 B1 relates to a hydrodynamic sliding bearing with a magnetic coupling pump, which is constituted as a combined axial and radial bearing. The sliding bearing of EP 0 814 275 B1 comprises two bearing sleeves, two bearing bushings capable of sliding on the bearing sleeves, a distance sleeve disposed between the bearing bushings and a distance bushing disposed between the bearing bushings. The bearing sleeves and bushings are made from a ceramic material, the distance sleeve or bushing being made from a metal. It order to create a hydrodynamic sliding bearing, which is intended to be producible cost-effectively and is intended to be constituted such that sufficient lubrication always arrives in the sliding bearing through the medium to be conveyed, EP 0 814 275 B1 proposes that the inner diameter of the bearing sleeves is greater than the inner diameter of the distance sleeve. Furthermore, EP 0 814 275 B1 proposes that a partial flow of the conveying medium passing the sliding bearing remote from the impeller is guided through a through-bore of the internal magnetic rotor into the containment shroud, from where the conveying medium passes into the through-bore of the shaft and is fed back into the suction region of the pump. A drawback with this embodiment can be that the desired forced guidance of the partial flow of conveying medium through the internal magnetic rotor into the pressure chamber and from there into the hollow-bored shaft does not take place if, for example, the corresponding pressure conditions are unfavorable. In such a case, the conveying medium heated by the magnetic power loss could be pressed against the actually intended (forced) flow direction through the internal magnetic rotor, or through its through-bore against the axial bearing element remote from the impeller, so that the concerned axial bearing element subjected to axial thrust is lubricated with the already heated partial conveying medium flow, which in the worst case can lead to damage to the bearing.

The problem underlying the invention is to improve or to create a conveying element, for example a magnetic coupling pump or a canned motor pump of the type mentioned at the outset, using straightforward means, wherein reliable cooling and lubrication with conveying medium is always guaranteed.

According to the invention, the problem is solved by a conveying element with the features of claim 1.

It should be pointed out that the features mentioned individually in the claims can be combined with one another in any technically reasonable manner and demonstrate further embodiments of the invention. The description characterizes and specifies the invention, in particular also in connection with the figures.

According to the invention, the conveying element is proposed in the exemplary embodiment as a magnetic coupling pump or a canned motor pump, wherein at least one channel system is introduced into the first drive element, i.e. in the first magnetic rotor for example, said channel system adjoining at least one connecting bore of the shaft, said connecting bore emerging in the through-bore.

The effect achieved by the invention is that the conveying medium, which is used amongst other things for lubrication of the sliding bearings, is guided from a point of maximum pressure by means of the channel system according to the invention and the connecting bore to a point of low pressure directly into the shaft or into its through-bore. This thus eliminates heated conveying medium from being able to pass from the containment shroud to the sliding bearing remote from the impeller; this is because the channel system in combination with the connecting bore is expediently disposed and constituted in such a way that the sliding bearing remote from the impeller, in particular its axial bearing element and radial bearing elements, does not have any fluidic connection with the cooling circuit for the heat removal of the magnetic power loss. The two conveying medium partial flows (cooling flow and lubrication flows) are not mixed until in the through-bore of the shaft, which will be dealt with further below.

In a preferred embodiment, provision can be made such that the channel system in the first drive element or in the first magnetic rotor has a first channel section running, as viewed in cross-section, parallel to the central axis of the shaft, said channel section transforming into a second channel section which is disposed at an angle to the latter and which is orientated in the direction of the outer periphery of the shaft.

It is possible that the first channel section has a clear inner diameter which is greater than a first partial section of the second channel section. It is also preferable if the second channel section is constituted conical at its end region orientated towards the shaft, i.e. at its second partial section, wherein the end section changes, for example widens, preferably conically to the magnitude of the inner diameter of the connecting bore. In this regard, a feasible embodiment is if the first partial section of the second channel section has a smaller inner diameter than the first channel section, wherein the second partial section of the second channel section changes, or can widen conically, preferably to the magnitude of the inner diameter of the connecting bore. It is obviously within the meaning of the invention if the second channel section has an unchanging cross-section over its entire extension, said unchanging cross-section preferably corresponding to the inner diameter of the connecting bore or to the inner diameter of the opening of the connecting bore at the outer side of the shaft.

The connecting bore, viewed in cross-section, is introduced into the shaft running at an angle to the central axis, wherein the connecting bore in a preferred embodiment is disposed with its central axis normal to the central axis of the shaft. In this regard, the connecting bore can also be referred to as a radial bore, which within the meaning of the invention extends from the outer surface of the shaft radially orientated up to its through-bore.

The conveying element or the exemplary magnetic coupling pump comprises the first drive element or the internal magnetic rotor and a bearing housing. Both lie adjacent to one another with corresponding surfaces, a media gap obviously being provided between the two surfaces (carrier starting zone), wherein a leakage flow, i.e. a partial flow, can flow through the media gap. In this regard, the media gap merely has the function of a leakage gap, wherein neither cooling nor lubrication is absolutely essential. The respective sliding bearing comprises radial bearing elements, i.e. a bearing bushing and a bearing sleeve and the axial bearing element or a bearing disc. Between mutually opposite sliding surfaces of the bearing bushing and the bearing sleeve is a lubrication groove, which is introduced into the sliding surface of the bearing bushing. The conveying medium passes both through the lubrication groove remote from the impeller, flowing past the bearing disc, and also through the media gap to the channel system according to the invention, where the two partial flows unite.

Furthermore, the conveying element or the magnetic coupling pump comprises a second drive element, which can also be referred to as the external magnetic rotor. The containment shroud is disposed between the two magnetic rotors. For the purpose of heat removal of the magnetic power loss, use is made of a cooling medium flow, which flows in inside the containment shroud into the cooling gap and emerges at the end side into the base region of the containment shroud, i.e. in a pressure chamber.

The cooling medium flow is obviously heated after passing through the cooling gap, a flow of heated medium from the pressure chamber to the sliding bearing remote from the impeller advantageously being avoided with the invention, as already explained above, by the fact that there is no direct flow connection of the sliding bearing remote from the impeller through the internal magnet carrier into the pressure chamber. The cooling medium flow passes out of the pressure chamber at all events directly into the through-bore of the shaft and is conveyed to the suction side of the conveying element or of the magnetic coupling pump. The flow through the hollow-bored shaft is well known in the prior art.

In order to increase the pressure in the entire region of the sliding bearing, provision is expediently made such that the lubrication groove dose to the impeller is constituted conically in its course in the direction of its outlet side to the bearing disc close to the impeller, wherein the lubrication groove close to the impeller preferably tapers towards the outlet side. A corresponding adaptation, i.e. a corresponding conical embodiment, solely of the surface of the bearing bushing close to the impeller is sufficient.

The pressure at the outlet of the lubrication groove (remote from the impeller) between the bearing sleeve and the bearing bushing is directly dependent on the feed-in quantity into the collecting chamber, from which the individual partial flows (cooling medium flow, lubrication flow), as it were, branch off. With an increasing feed-in quantity, the dynamic pressure increases at the (inner) end face of the internal magnetic rotor, which leads to a reduction in the axial thrust towards the suction side, wherein the axial bearing element (remote from the impeller), or the bearing disc (remote from the impeller), is relieved of load.

It is also favorable that more conveying medium in percentage terms flows through the cooling gap than through the media gap. In order to achieve the effect of reducing further the partial flow through the media gap, the cooling medium flow through the cooling gap being further increased at the same time, which immediately brings about a pressure reduction at the outlet of the media gap to the bearing disc, so that the lubricating medium flow for the lubrication of the sliding bearing (remote from the impeller) is forcibly guided, flowing via the bearing disc, into the channel system into the low-pressure region, provision is expediently made such that the media gap comprises a flow varying element, preferably constituted as a throttle element. The partial flow quantity in the media gap or in the carrier starting zone is reduced by means of the flow varying element or the throttle element. The flow varying element can be constituted as a labyrinth, wherein provision is expediently made such that the grooves of the labyrinth are introduced into the corresponding surface of the bearing housing, i.e. in a non-rotating component. The pressure at the end face that acts on the inner end face of the internal magnetic rotor also increases in parallel by means of these measures, the effect of which is that the partial flow quantity via the cooling gap, or the cooling medium flow, as already mentioned, is increased, as a result of which, for example in the case of low-boiling media to be conveyed, the heat input into the medium is reduced due to the greater tangential flow through the cooling gap. Furthermore, the axial thrust of the pump can be better controlled with the advantageous measure, since the prevailing pressure on the end face of the internal magnetic rotor is increased in terms of magnitude, as a result of which the axial bearing element remote from the impeller or the bearing disc remote from the impeller is relieved of load.

It is of course also quite within the meaning of the invention if not only a single channel system is disposed in the first drive element or in the internal magnetic rotor, which makes available a flow path for the said partial flows through the assigned connecting bore into the through-bore of the shaft, thereby bypassing the containment shroud pressure chamber. It is conceivable for a plurality of channel systems to be provided, which emerge into connecting bores assigned in each case. Four channel systems and four connecting bores, for example, can accordingly be introduced into the components concerned, wherein the connecting bores are introduced into the shaft with their peripheral mouth opening distributed uniformly around the periphery.

It is also within the meaning of the invention that the individual partial flows of the conveying medium removed from the region of maximum pressure branch off, as it were, from a collecting chamber, in order thus to enable on the one hand the heat removal of the magnetic power loss in the cooling gap and on the other hand the leakage flow in the media gap or the lubrication in the lubrication groove close to the impeller and remote from the impeller. The collecting chamber is bounded by the inner end face of the internal magnetic rotor, the containment shroud and the bearing housing. It is expedient in the invention that, in particular, the lubricating medium flow of the sliding bearing remote from the impeller is forcibly guided via the axial bearing element, or via the bearing disc, through the channel system into a low-pressure region, without flowing into the pressure chamber of the containment shroud.

Further advantageous embodiments of the invention are disclosed in the sub-claims and the following description of the figures. In the figures:

FIG. 1 shows a magnetic coupling pump in a cross-sectional representation, and

FIG. 2 shows the magnetic coupling pump from FIG. 1 in a magnified partial detail.

In the various figures, identical parts are always provided with the same reference numbers, for which reason the latter are described only once.

FIG. 1 shows a conveying element 1 in the exemplary embodiment as a magnetic coupling pump 1 with a pump shaft 2, e.g. a special steel shaft 2, which carries an impeller 3, and which is mounted in a hydrodynamic sliding bearing 4, wherein hydrodynamic sliding bearing 4 can be lubricated externally by conveying medium, but also by another product-compatible fluid.

Magnetic coupling pump 1 comprises a sliding bearing 4a close to the impeller and a sliding bearing 4b remote from the impeller. Respective sliding bearing 4 comprises a bearing sleeve 6, a bearing bushing 7 and an axial bearing element 8 or a bearing disc 8, wherein in the following, as an addition to the reference number concerned, the letter a is selected for the components close to the impeller and the letter b is selected for the components remote from the impeller.

A lubrication groove 9 (close to the impeller) and 11 (remote from the impeller) is disposed in each case between respective bearing bushing 7 and respective bearing sleeve 6 (FIG. 2), said lubrication groove being introduced into bearing bushing 7. Respective lubrication groove 9 and 11 can be constituted with a rounded course, which has a curvature which, relative to a central axis of bearing bushing 7, is orientated away from the latter, i.e. is preferably constituted convex. A bearing housing 12 projects with an extension 13 into the intermediate space of mutually opposite bearing bushings 7. Extension 13 is spaced apart from distance sleeve 14 viewed in the radial direction, so that a lubrication pocket 16 (FIG. 2) is formed,

Shaft 2 carries a first drive element 17, which is connected to the latter in a rotationally fixed manner and which is referred to as internal magnetic rotor 17 in the following. Internal magnetic rotor 17 engages over bearing housing 12 in sections, so that a so-called carrier starting zone 18 is formed, in which a media gap 19 (FIG. 2) is disposed. Media gap 19 is thus disposed between mutually opposite surfaces of bearing housing 12 and of internal magnetic rotor 17.

Internal magnetic rotor 17 is in an operative connection with a driven second drive element 21, which is referred to in the following as external magnetic rotor 21. Disposed between the two magnetic rotors 17 and 21 is a containment shroud 22, which comprises a base lying opposite impeller 3, so that a pressure chamber 23 is formed. Disposed between containment shroud 22 and internal magnetic rotor 17 is a cooling gap 24, which emerges into pressure chamber 23.

Introduced into shaft 2 is a through-bore 26, which is open towards pressure chamber 23. Lying opposite, through-bore 26 comprises a media connection, or a further channel system, to impeller 3 of exemplary magnetic coupling pump 1.

Exemplary magnetic coupling pump 1 is known per se, for which reason it will not be described further.

The invention is aimed at the advantageous partial flow guide for the cooling and lubrication of magnetic coupling pump 1, for example with conveying medium.

The conveying medium is removed at a point of maximum pressure 27 (which is intended to be shown merely by way of example in FIG. 2) and is conveyed via a bore 28 through housing cover 29 into collecting pocket 31. Collecting pocket 31 is formed on the one hand by a partial section of containment shroud 22, a partial section of bearing housing 12 and end face 32 of internal magnetic rotor 17 lying remote from the impeller.

The medium flow (total feed-in quantity, arrow 33) guided into collecting pocket 31 is split up into a cooling medium flow (arrow 34) and a lubricating medium flow (arrow 36). Cooling medium flow 34 flows with a partial flow 37 through cooling gap 24 into pressure chamber 23, and is conveyed with a second partial flow 38, i.e. with a leakage flow 38, via media gap 19. Lubricating medium flow 36 is conveyed via a bore 39 in bearing housing 12 out of collecting pocket 31 to lubrication pocket 16, in which the inlet sides of the two lubrication grooves 9 and 11 emerge.

Provision is expediently made according to the invention such that at least one channel system 41 is disposed remote from the impeller in internal magnet carrier 17, said channel system emerging in a connecting bore 42 disposed in shaft 2. Connecting bore 42 extends with its central axis, as represented by way of example, normal to the central axis of shaft 2, and emerges in through-bore 26 of shaft 2. With its other opening, connecting bore 42 ends at the outer periphery of shaft 2.

Channel system 41 comprises two channel sections 43 and 44. The first channel section 43 extends, viewed in cross-section, for example parallel to the central axis of shaft 2 and transforms into second channel section 44, which in a first partial section 46 can first have a smaller inner diameter relative to first channel section 43. First partial section 46 transforms into a second partial section 47, which can be constituted conical. In a possible embodiment, second partial section 47, or the end section of second channel section 44, widens, viewed in cross-section, conically at the end to the magnitude of the diameter of connecting bore 42. A preferred embodiment of second channel section 44 is represented in FIG. 2, said second channel section having in its two partial sections 46 and 47 in each case a continuously constant cross-section which preferably corresponds to the inner diameter of connecting bore 42. Second channel section 44 extends with its two partial sections 46 and 47 for example as a radially orientated bore or pocket up to the inner periphery of internal magnet carrier 17, and joins up with connecting bore 42, so that a flow path is also formed for the partial flow out of sliding bearing 4b, bypassing pressure chamber 24, directly into through-bore 26. As can be seen from FIG. 2, it is possible for not just a single connecting bore 42 to be provided. On the contrary, a plurality, for example four, connecting bores 42 (of which three can be seen in FIG. 2) can be provided, so that four channel systems 41 can also be correspondingly introduced into internal magnetic rotor 17. The central axes of respectively adjacent connecting bores 42 each lie normal (90°) to one another.

Lubricating medium flow 36 is split up into two lubrication partial flows 48 and 49. First lubrication partial flow 48 flows through lubrication groove 11 remote from the impeller around axial bearing element 8b remote from the impeller into channel system 41 according to the invention and from here through connecting bore 42 directly into through-bore 26 of shaft 2.

Cooling medium flow 34 and respectively 37 guided into pressure chamber 23 also passes into through-bore 26, so that said cooling medium flow is mixed in through-bore 26 with first lubrication partial flow 48, which has been mixed with partial flow 38 via media gap 19 in channel system 42 according to the invention. This mixed medium flow 50 is conveyed through through-bore 26 in the direction of impeller 3.

It is expedient that a mixing of cooling medium flow 34 and first lubrication partial flow 48 cannot occur until in through-bore 26 of shaft 2, wherein mixing in pressure chamber 23 is excluded, so that an admission of heated cooling medium flow to sliding bearing 4b remote from the impeller is at all events avoided.

In order to increase the pressure in the entire sliding bearing region, provision is made in an embodiment of the invention such that lubrication groove 9 close to the impeller is constituted conical. Provision is preferably made such that lubrication groove 9 close to the impeller is conically tapered in its inner diameter from its inlet side orientated towards lubrication pocket 16 to the opposite-lying outlet side, wherein only bearing bushing 7a (close to the impeller) is machined on its surface in such a way that the conical course of lubrication groove 9 close to the impeller results. Lubrication partial flow 49 is mixed with medium flow 50 conveyed out of shaft 2 to form a total flow 51 which is fed to impeller 3.

The pressure of the medium at the outlet from lubrication groove 11 remote from the impeller is directly dependent on the feed-in quantity of the medium into collecting pocket 31. The dynamic pressure at end face 32 of internal magnetic rotor 17 close to the impeller increases with increasing feed-in quantity into collecting pocket 31, which leads to a reduction in the axial thrust towards the suction side, as a result of which bearing disc 8 remote from the impeller is relieved of load.

As already stated, the feed-in quantity in collecting pocket 31 splits up into cooling medium flow 34 or into partial flows 37 and 38 and lubricating medium flow 36. For example, the end-face pressure on end face 32 has an amount of 80% of the conveying pressure of magnetic coupling pump 1. A part (partial flow 37), for example 65%, of cooling medium flow 34 flows through cooling gap 24, wherein the other part, e.g. 35% (partial flow 38), flows through media gap 19 to channel system 41. It should be pointed out that only percentage amounts of cooling medium flow 34, i.e. of the two partial flows 37 and 38, are stated here, wherein partial flow 38 does not necessarily have to bring about cooling or lubrication, but is merely a leakage flow. It is of course within the meaning of the invention that cooling medium flow 34, i.e. the sum of partial flow 37 and partial flow 38, also corresponds only a percentage amount of the quantity fed to collecting pocket 31. It can thus arise that, with a total feed-in quantity into collecting pocket 31 of 100%, for example 10-40%, preferably 20-30%, still more preferably 25% of the total feed-in quantity passes as lubricating medium flow 36 through bore 39 to lubrication pocket 16, wherein cooling medium flow 34, i.e. the two partial flows 37 and 38 together, corresponds for example to an amount of 90-60%, preferably 80-70%, still more preferably 75% of the total feed-in quantity into collecting pocket 31.

In order to reduce the partial flow quantity that flows through media gap 19 (arrow 34, 38), the latter can comprise, in a further embodiment of the invention, a flow varying element 52, preferably a throttle element in the exemplary embodiment as labyrinth 52, so that the amount of partial flow 38 that flows through media gap 19 is reduced by way of example by 10-30%, for example by 20%, wherein at the same time the amount of cooling medium flow 34 through cooling gap 24 is increased by way of example by 10-30%, for example by 20%. At the same time, the end-face pressure on end face 32 of internal magnetic rotor 17 close to the impeller is thus increased, as a result of which the pressure at the outlet of media gap 19 is reduced, so that first lubrication partial flow 48 for lubricating sliding bearing 11 remote from the impeller is forcibly guided into a low-pressure region. Cooling medium flow 34 and respectively 37 is increased in terms of amount with the increase in the end-face pressure acting on end face 32 close to the impeller, so that for example, in the case of low-boiling media, the heat input into cooling medium flow 34 and respectively 37 is reduced by the greater tangential through-flow, the axial thrust of magnetic coupling pump 1 also being able to be controlled better, since bearing disc 8b remote from the impeller is relieved of load. Throttle element 52 could also be constituted as a conveying screw. It is expedient if throttle element 52 is disposed in the non-rotating component. Throttle element 52 constituted as labyrinth 52 comprises, viewed in the axial direction, grooves 54 spaced apart from one another, which are disposed or introduced in the surface concerned, preferably of bearing housing 12. Four grooves 54 following one another are provided merely by way of example, wherein partial flow 38 is swirled, which has an effect on reducing the through-flow quantity. This is indicated in FIG. 2 by means of the smaller arrows above grooves 54. Throttle element 52 produces an increase in pressure at the inlet of media gap 19 and a reduction in pressure at the opposite outlet of media gap 19. As a result of the inlet-side pressure increase at media gap 19, the end-face pressure at end face 32 of internal magnetic rotor 17 close to the impeller is also increased. More or fewer than the four grooves shown by way of example can of course also be provided.

With the invention, a partial flow guide is achieved in magnetic coupling pumps, with which cooling and lubrication is always ensured. A flow path along channel system 41 and connecting bore 42 directly into shaft 2 or into its through-bore 26 is made available in particular for first lubrication partial flow 48, wherein the introduction of any lubrication partial flow into pressure chamber 23 of containment shroud 22 is avoided. A direct connection of pressure chamber 23 to sliding bearing 4b remote from the impeller is thus eliminated at the same time, so that penetration of heated medium into sliding bearing 4b remote from the impeller is also avoided. The medium removed at the point of maximum pressure 27 is fed back behind impeller 3 (total flow 51), wherein evaporation of the medium in the magnetic coupling pump is prevented by the advantageous pressure superposition. The removed medium flow is fed back into the blades of impeller 3 through equalizing bores 53 in impeller 3, preferably at a point of higher pressure.

The partial flow guide of exemplary magnetic coupling pump 1 comprises the following flow path:

Conveying medium is removed at a point of maximum pressure and fed to collecting pocket 31. The lubrication medium flow passes from collecting pocket 31 into lubrication pocket 16, wherein partial flows 37 and 38 are guided on the one hand through cooling gap 24 into pressure chamber 23 and on the other hand through media gap 19 in the direction of at least one channel system 41. The lubrication medium flow is split up into two partial flows 48 and 49, whereof first partial flow 48 is guided through lubrication groove 11 remote from the impeller in the direction towards channel system 41 according to the invention. In channel system 41, the two flows 48 and 38 are mixed and are conveyed via connecting bore 42 into through-bore 26 of shaft 2. It is only here that mixing of flows 38 and 48 with cooling medium flow 34 and respectively 37 is allowed to take place. Total flow 50 flows through shaft 2 in the direction of impeller 3, and is mixed with second lubrication partial flow 48, which flows through conically constituted lubrication groove 9 close to the impeller. The removed conveying medium flow for cooling and lubrication is thus fed back, wherein small losses can of course be expected.

### List of Reference Numbers:

1 magnetic coupling pump

2 pump shaft

3 impeller

4 hydrodynamic sliding bearing

5

6 bearing sleeve

7 bearing bushing

8 axial bearing element

9 lubrication groove (close to impeller)

10

11 lubrication groove (remote from impeller)

12 bearing housing

13 extension

14 distance sleeve

15

16 lubrication pocket

17 first drive element

18 carrier starting zone

19 media gap

20

21 second drive element

22 containment shroud

23 pressure chamber

24 cooling gap

25

26 Through-bore

27 point of maximum pressure

28 bore

29 housing cover

30

31 collecting pocket

32 end face of 17 close to impeller

33 medium flow

34 cooling medium flow

35

36 lubrication medium flow

37 partial flow of 34 through 24

38 partial flow of 34 through 19

39 bore

40

41 channel system

42 connecting bore

43 first channel section of 41

44 second channel section of 41

45

46 first partial section of 44

47 second partial section of 44/end section of 44

48 first lubrication partial flow through 11

49 second lubrication partial flow through 9

50 medium flow led out

51 total flow

52 flow varying element/throttle element

53 equalising bore

54 grooves of 52

What is claimed is:

1-10. (canceled)

11. A magnetic coupling pump, comprising:
a containment shroud having a pressure chamber;
a shaft having a through-bore in communication with the pressure chamber;
a sliding bearing assembly configured to support the shaft;
an internal magnetic carrier having at least one channel system which adjoins at least one connecting bore which extends from an outer periphery and feeds into the through-bore of the shaft; and
a throttle element arranged in a media gap between a bearing housing of the sliding bearing assembly and the internal magnetic carrier, said throttle element being formed as a labyrinth in a surface of the bearing housing.

12. The magnetic coupling pump of claim 11, wherein the at least one channel system has a first channel section which extends in parallel relation to a central axis of the shaft, and a second channel section which is orientated in a direction of the outer periphery of the shaft, said first channel section feeding into the second channel section.

13. The magnetic coupling pump of claim 12, wherein the second channel section of the at least one channel system has a continuously constant cross-section.

14. The magnetic coupling pump of claim 12, wherein the second channel section of the at least one channel system has an end section which has a conical configuration.

15. The magnetic coupling pump of claim 11, wherein the connecting bore is defined by a central axis extending at an angle to a central axis of the shaft.

16. The magnetic coupling pump of claim 15, wherein the connecting bore is configured as a radial bore.

17. The magnetic coupling pump of claim 11, further comprising an impeller supported by the shaft, with the sliding bearing assembly having an impeller-distal sliding bearing and an impeller-proximal sliding bearing, said at least one channel system being configured to unite a medium flow, which flows through the media gap, with a first lubrication partial flow, which flows through a lubrication groove of the impeller-distal sliding bearing.

18. The magnetic coupling pump of claim 11, wherein the internal magnetic carrier and the containment shroud define a cooling gap there between for guiding a cooling medium flow to the pressure chamber of the containment shroud and from there into the through-bore of the shaft, with the cooling medium flow being mixed with a medium flow and a first lubrication partial flow, mixed with the medium flow, only in the through-bore.

19. The magnetic coupling pump of claim 17, wherein the impeller-proximal sliding bearing has a lubrication groove of conical configuration from an inlet side in a direction towards an opposite outlet side.

20. The magnetic coupling pump of claim 17, wherein the impeller-proximal sliding bearing has a lubrication groove which tapers conically from an inlet side in a direction towards an opposite outlet side.
